(19) United States
(12) Patent Application Publication
(10) Pub. No.: US 2008/0049212 A1
(43) Pub. Date: Feb. 28, 2008

(54) Apparatus for gravitation-compensated mounting of a measurement object

(76) Inventor: Ralf Lenke, Lauchheim (DE)

Correspondence Address: GRAY ROBINSON, P.A., P.O. Box 2328, FT. LAUDERDALE, FL, 33303-9998, US

(21) Appl. No.: 11/844,475

(22) Filed: Aug. 24, 2007

(30) Foreign Application Priority Data
Aug. 25, 2006 (DE) 10 2006 039 820.3

(51) Int. Cl. G02B 7/185

(52) U.S. Cl. 356/18

(57) ABSTRACT

An apparatus is provided for gravitation-compensated mounting of a measurement object (2) having a plurality of supporting elements (1) which each act at at least one point on the measurement object (2), with the supporting elements (1) being designed such that they exert a constant force when small changes occur in the position of the measurement object (2). The supporting elements (1) are provided with floating bodies (3) arranged in a carrier liquid (7).

### CROSS REFERENCE TO RELATED APPLICATION

This application related to and claims priority to corresponding German Patent Application No. 10 2006 039 820.3, which was filed on Aug. 25, 2006, and which is incorporated by reference herein.

### BACKGROUND OF THE INVENTION

1. Field of the Invention

The invention relates to an apparatus for gravitation-compensated mounting of measurement objects.

2. Description of the Related Art

Optical components which have a considerable extent have been used for several decades, in particular in astronomy. One continuous requirement for the production and in particular for the testing and measurement of such components is to find a reasonable compromise between the stiffness required for the components, which are normally manufactured with high precision, and a weight that is as low as possible. It is also desirable to find a possible way to mount these components in a stable and precise manner both when in use in the field and during manufacture and quality control of these components. The stated problems are addressed in German Laid-Open Specifications DE 39 08 430 A1 and DE 36 03 217 A1. Furthermore, the described problems are dealt with in German Patent DE 35 21 973 C1, and in US Patent Application US 2002/0150399 A1 and U.S. Pat. No. 3,761,158. Furthermore, International Patent Application WO 03036360 A1 describes one possible way for mounting an object, with the object being held by means of pneumatic holders which are connected to a supply reservoir whose volume is sufficiently large. In this case, the large volume of the supply reservoir results in the holder exerting an approximately constant force on the object in response to small deflections. However, the solution proposed in the cited document is subject to the problem of the need for complex control of the individual pneumatic holding elements.

### SUMMARY OF THE INVENTION

The object of the present invention is to provide an apparatus for gravitation-compensated mounting of a measurement object, which ensures stable and precise mounting of the measurement object with little hardware complexity.

This object is achieved by the apparatus having the features stated in Patent Claim 1; the dependent claims relate to advantageous developments and refinements of the invention.

The apparatus according to the invention has a plurality of supporting elements which each act at one point on the measurement object, with the supporting elements being designed such that a constant force is exerted on the measurement object in response to small changes in its position; this is achieved by providing the supporting elements with floating bodies which are arranged in a carrier liquid. The measurement object may in this case be located in or outside the liquid. In this case, the expression small position changes means in particular changes of less than about 10 mm. These position changes occur more than 70%, in particular more than 90% in the vertical direction. The buoyancy that is produced by the floating bodies results in a supporting and gravitation-compensating force being exerted via the supporting elements at a large number of points on the measurement object. In other words, the measurement object is imagined as being subdivided into n segments, with each segment being supported by one supporting element. In this case, the force exerted by the supporting element corresponds precisely to the force created by the weight acting on the respective segment, or the “weight minus lift” in the situation where the measurement object is located in the liquid. The segments can be chosen such that each of them exerts the same force resulting from weight on its respective supporting element; alternatively, segments with a different mass can be chosen, and the supporting elements and the floating bodies in each case associated with them can be appropriately matched. This method results in the measurement object being mounted in a stable manner, effectively avoiding, in particular the measurement object bending as a result of the gravitational force. The described apparatus can be used particularly advantageously for mounting measurement objects which are intended for subsequent use in zero-gravity conditions. Particularly for measurement objects such as these, the effect of gravitation must be particularly effectively precluded during measurement and quality control.

The floating bodies have a density which is less than the density of the carrier liquid surrounding them. The floating bodies are preferably located completely under the supporting liquid level. If the floating bodies are completely immersed in the carrier liquid, their buoyancy force is always the same.

By way of example, a measurement object of about 200×100×0.5 mm and a natural weight of about 25 g can be supported by approximately 20 such supporting elements with adequate stability and precision.

One advantageous choice for the shape of the supporting elements is for them to be elements which are in the form of rods and are arranged such that they can move at least approximately vertically in the carrier liquid. In order to ensure the vertical orientation of the elements which are in the form of rods in this case, a guide apparatus can be used which, for example, may comprise two perforated plates, which are arranged approximately horizontally, and each have mutually opposite holes, with the elements which are in the form of rods being passed, such that they slide, through the holes. In this case, the orientation of the elements which are in the form of rods from the vertical and/or the perforated plates from the horizontal may differ by a value of 0° to about 10°, preferably by a value of 0° to about 5°.

In order to ensure the stable position of the measurement object in particular during a measurement, it has been found worthwhile to design at least one holding element, that is to say a supporting element, without a floating body and such that it is fixed.

One advantageous variant for provision of the floating bodies is for them to be hollow bodies, in particular glass bodies. Bodies such as these can be produced easily for example by a glass blower, and are available in a wide range of variants.

In order to match the force which results from the buoyancy of floating bodies, it has been found appropriate to fit weights to the supporting elements, whose density is greater than that of the surrounding carrier liquid; lead weights have been found to be particularly suitable for an application such as this.

One alternative to this is to design the floating bodies which, for example, are in the form of hollow glass bodies, to be open at the bottom, with the internal cavity in the glass bodies to be at least partially filled with a buoyant medium whose density is less than that of the surrounding carrier liquid. An oil, gas or a solid may be used, for example, for the buoyant medium in this case, with water being used for the carrier liquid. This variant of the invention provides a particularly simple capability of matching the resultant supporting force.

In a first alternative, fine adjustment can be carried out by means of the amount of buoyant medium in the hollow glass body. For this purpose, for example, oil can be deliberately introduced into the cavities which are open at the bottom via an opening at the bottom of the reservoir in which the apparatus is located. In order to reduce the resultant supporting force, the oil can be let out through an opening at the top of the hollow glass body. The water which flows back into the cavity in this case reduces the volume of the water displaced by the hollow floating bodies and therefore reduces the buoyancy force exerted by the floating body. In this case, it is also feasible to equip the glass body with two cavities, one of which is closed and contains a gas, e.g. air, and in this way provides the majority of the required buoyancy, with the second cavity being formed by the cavity that is open at the bottom as already described, and which allows fine adjustment of the resultant supporting force by means of the oil level in it.

A second variant for adjustment of the resultant supporting force is to vary the density of the oil in the glass body that is open at the bottom, rather than its amount, by means of a change in temperature: for this purpose, by way of example, the oil can be heated by means of a laser beam or some other light source whose radiation is at least partially absorbed by the oil in the glass bodies, thus changing the density of the oil, and therefore the resultant buoyancy. This variant would allow individual glass bodies to be illuminated selectively, in this way influencing the resultant supporting force applied to the associated supporting elements.

One alternative to this procedure is to fit containers which are open at the top to the floating bodies or to the supporting elements, and to fill these containers as required with a ballast liquid or some other ballast medium. In this case, a ballast medium of virtually any desired density can be used if the opening of the containers is above the liquid level of the carrier liquid.

One possible way to vary the resultant supporting force uniformly for all of the supporting elements is to vary the density of the carrier liquid. This can be done, for example, by deliberately varying the concentration of a substance dissolved in the carrier liquid, such as sodium chloride, in the carrier liquid, or by varying the temperature of the carrier liquid, and therefore its density. Since the floating bodies generally have a thermal coefficient of expansion which is not the same as that of the carrier liquid, this results in a change in the buoyancy, and therefore in the resultant supporting force.

### BRIEF DESCRIPTION OF THE DRAWINGS

One exemplary embodiment of the invention will be described in the following text with reference to FIGS. 1 to 4. In this case:

FIG. 1: shows a section through one embodiment according to the invention of the apparatus with a low liquid level,

FIG. 2: shows a section through one embodiment according to the invention of the apparatus with a high liquid level,

FIG. 3: shows a view from above of the embodiment according to the invention shown in FIG. 1, and

FIG. 4: shows a detail of the apparatus shown in FIGS. 1 and 2.

### DETAILED DESCRIPTION

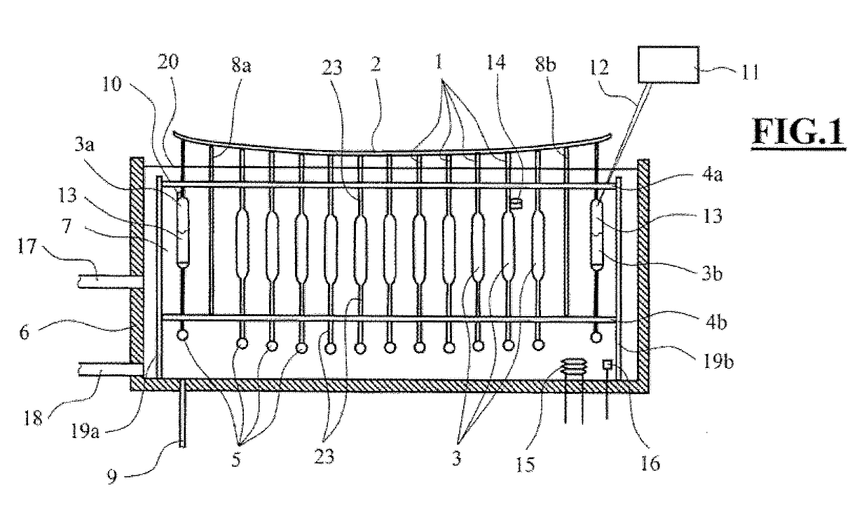

The cross section, in the form of a sketch, as illustrated in FIG. 1 through the arrangement according to the invention shows a measurement object 2 mounted on a large number of floating supporting elements 1. The floating supporting elements 1 in this case each have one floating body 3, and are adjusted to be in an approximately vertical position by means of the stationary guide plates 4a and 4b of the guide frame 22. A plurality of floating bodies 3 can also be provided for each supporting element 1, instead of one floating body 3. The guide plates 4a and 4b are arranged fixed to the basin via stand legs 19a to 19d. The fixed arrangement can be provided by means of gravity or fixing to the basin base or the basin wall.

Lead weights 5 are fitted, such that they can be detached or are fixed, to the lower face of the supporting elements 1, for adaptation of the resultant supporting force. The entire arrangement is located in the basin 6, which is filled with a carrier liquid 7, such as water. Additional stability is provided for the measurement object 2 by the three stationary holding elements, that is to say supporting elements without floating bodies, 8a, 8 and 8c. These three holding elements 8a, 8b, 8c are firmly connected to the supporting framework 22. It is also possible to provide more than three such stationary holding elements 8.

The floating bodies can, for example, be formed by gases or liquids of lower density than the density of the surrounding liquid 7. Floating bodies made from solids are also feasible.

The supporting rods 23 which connect the floating bodies 3 to the lead weights 5 and to the measurement object 2 can be produced from robust material, for example steel. As a result of the necessary robustness, a material of higher density than the density of the carrier liquid 7 can be used for the supporting rods 23.

In addition, FIG. 1 shows further variants, illustrating how it is possible to vary the resultant force exerted by the supporting elements 1 on the measurement object 2. In this case, in a first variant, the floating body 3a is a floating body which is open at the bottom and in whose lower part the floating liquid 13, for example oil whose density is less than that of the carrier liquid 7, is located; an air cushion is located in the upper area of the floating body 3a, and its volume can be adapted by operation of the outlet 10. It is, of course, also feasible for the floating body 3a to be filled completely with the buoyant liquid 13 or, if required, for the buoyant liquid 13 to be located in the upper area of the floating body 3a, while the lower area of the floating body 3a is occupied by the carrier liquid 7. The floating body 3a can be supplied with the buoyant liquid 13 through the supply opening 9; in this case, the buoyant liquid 13 rises through the surrounding carrier liquid 7 in the direction of the floating body 3a, and enters it through the lower opening in the floating body 3a.

In contrast to this, the supporting force exerted by the floating body 3b is varied by providing a laser 11 which irradiates the interior of the floating body 3b with a laser beam 12. The absorption of the energy from the laser beam 12 in the buoyant liquid 13 in the interior of the floating body 3b results in a buoyant liquid 13 being heated and changing its density, thus changing the volume occupied by it in the floating body 3b. In the end, this results in a variation of the supporting force exerted by the floating body 3b. In addition, a container 14 is shown which, for example, can be filled with a ballast liquid.

Furthermore, FIG. 1 shows two possible ways to vary the density of the carrier liquid 7. In a first variant, a substance which is or can be dissolved in the carrier liquid 7 is supplied via the inlet 17, thus resulting in a change in the density of the carrier liquid 7. The liquid level of the carrier liquid 7 can in this case be adapted, or kept constant, via the outlet 18.

As an alternative to this, or else in addition to it, it is feasible to the use the heating/cooling coil 15, to adapt the temperature and thus the density of the carrier liquid 7. In this case, the temperature of the carrier liquid 7 can be regulated by means of the temperature sensor 16, via a control loop that is not illustrated.

The measurement object 2 can be supported in air or in a gas. It is also feasible for it to be supported in a further liquid, which is located on top of the carrier liquid 7, because its density is less.

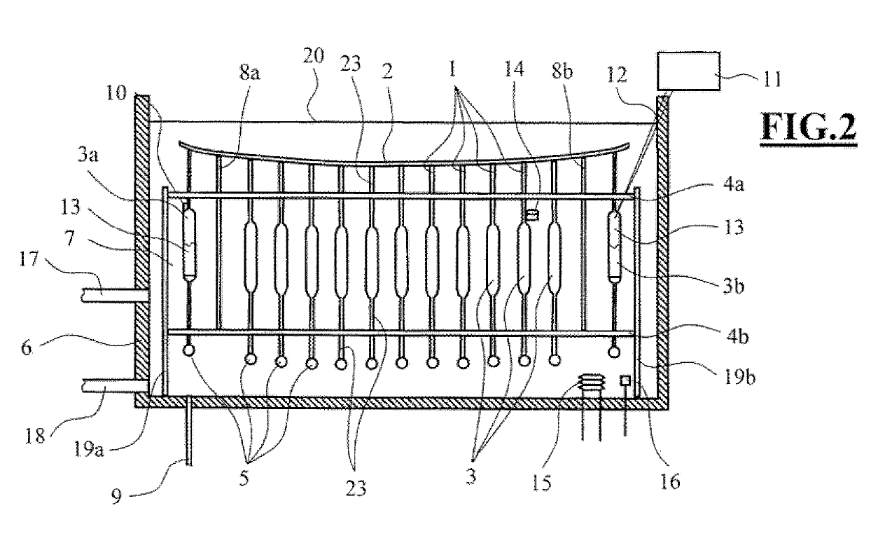

FIG. 2 shows the embodiment shown in FIG. 1, but now with a liquid level 20 which is sufficiently high that the measurement object 2 is located under the liquid level. In this case, the measurement object must be protected against external influences, for example dirt or local temperature fluctuations.

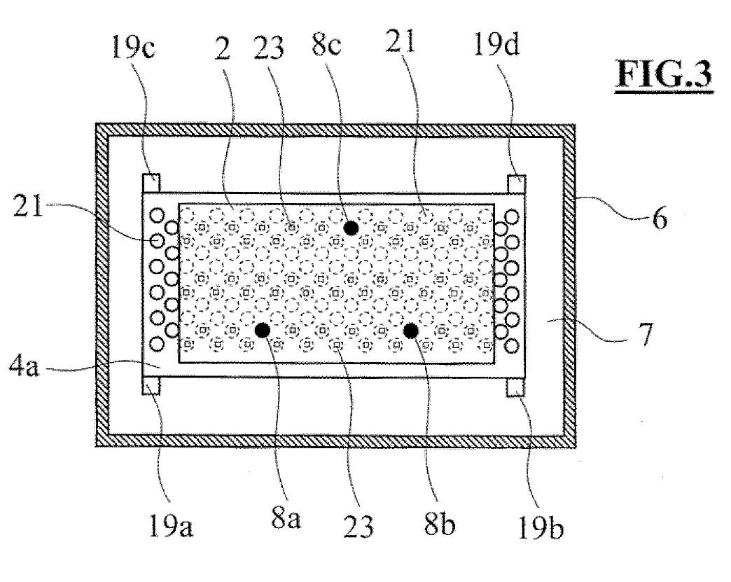

FIG. 3 shows the embodiment shown in FIG. 1 from a bird's-eye perspective. As can be seen, the measurement object 2 is arranged in the basin 6, which is filled with the liquid 7. The measurement object 2 is, for example, a transparent, rectangular and curved mirror. The three holding elements without floating bodies 8a, 8b and 8c can be seen through the mirror. The holes 21 in the upper guide plate 4a are represented by dashed lines below the mirror. The supporting elements 1 support the measurement object 2 through these holes.

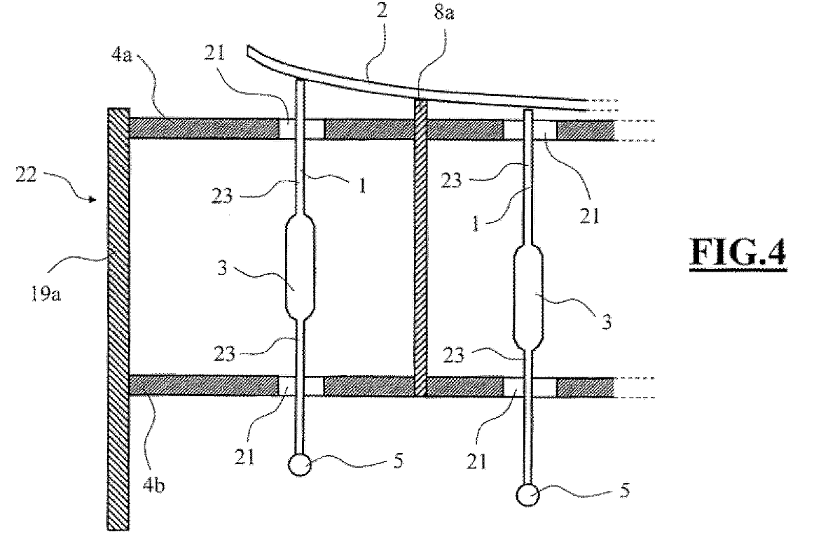

FIG. 4 shows a detail of the embodiment shown in FIGS. 1 and 2. In this case, the figures show the guide frame 22 with one of its stand legs 19a, the two guide plates 4a and 4b with multiple holes, and a holding element 8a which has no floating bodies and is attached to the guide frame 22. The measurement object 2 lies on the stationary holding element 8a, which has no floating bodies, and, in addition, on the two floating supporting elements 1 with floating bodies 3. The floating supporting elements 1 are passed through the holes 21 in the guide plates 4a and 4b, at least approximately vertically, in the liquid 7 in the basin 6.

### List of Reference Symbols

1 supporting elements
2 measurement object
3 floating body
4a, 4b guide plates
5 lead weight
6 basin
7 carrier liquid
8a, 8b, 8c holding elements, that is to say supporting elements without any extra floating bodies
9 inlet opening to the floating body
10 outlet from the floating body
11 laser
12 laser beam
13 buoyant liquid
14 additional container
15 heating/cooling coil
16 temperature sensor
17 basin inlet
18 basin outlet
19a, 19b, 19c, 19d stand legs
20 liquid level
21 holes
22 guide frame
23 supporting rods

What is claimed is:

1. Apparatus for gravitation-compensated mounting of a measurement object, having a plurality of supporting elements which each act at least one point on the measurement object, with the supporting elements being designed such that they exert a constant force when small changes occur in the position of the measurement object, wherein the supporting elements are provided with floating bodies located in a carrier liquid.

2. Apparatus according to claim 1, wherein the supporting elements are elements which are in the form of rods and are arranged such that they can move at least approximately vertically in the liquid, in particular with a discrepancy of less than 5° or 10° from the vertical.

3. Apparatus according to claim 2, wherein a guide apparatus is additionally provided and is used to hold the supporting elements in their approximately vertical position.

4. Apparatus according to claim 3, wherein the guide apparatus has two approximately horizontal perforated plates with mutually opposite holes, through which the supporting elements are passed.

5. Apparatus according to claim 1, wherein at least one stationary holding element, in particular three holding elements, is provided.

6. Apparatus according to claim 5, wherein at least one holding element is arranged fixed on the guide apparatus.

7. Apparatus according to claim 1, wherein the floating bodies are hollow bodies filled with a buoyant medium, or solid bodies.

8. Apparatus according to claim 1, wherein additional weights, in particular lead weights, are provided in order to match the force which results from the buoyancy of the floating bodies.

9. Apparatus according to claim 7, wherein the floating bodies are open at the bottom and are at least partially filled with a buoyant medium with a lower density than that of the surrounding carrier liquid.

10. Apparatus according to claim 9, wherein means are provided for variation of the volume occupied by the buoyant medium in the floating bodies.

11. Apparatus according to claim 10, wherein means are provided to vary the density of the buoyant medium in the floating bodies by means of a change in temperature, in particular by the absorption of electromagnetic radiation.

12. Apparatus according to claim 10, wherein means are provided in order to supply the buoyant medium to the interior of the floating bodies and/or to let the buoyant liquid out from them.

13. Apparatus according to claim 1, wherein at least one additional container, for filling with a ballast of defined density, is fitted to at least one supporting element or floating body.

14. Apparatus according to claim 1, wherein means are provided for variation of the density of the carrier liquid.

15. Apparatus according to claim 14, wherein means are provided for variation of the concentration of a substance which is dissolved in the carrier liquid.

16. Apparatus according to claim 14, wherein means are provided for variation of the temperature of the carrier liquid.

17. Apparatus according to claim 7, wherein gases, liquids, solids or mixture of them are used as the buoyant medium.
